(19) United States
(12) Patent Application Publication
(10) Pub. No.: US 2001/0045787 A1
(43) Pub. Date: Nov. 29, 2001

(54) Permanent magnet synchronous motor

(75) Inventor: Gerhard Huth, Leutershausen (DE)

Correspondence Address: HENRY M FEIEREISEN, 350 FIFTH AVENUE, SUITE 3220, NEW YORK, NY, 10118

(73) Assignee: SIEMENS AKTIENGESELLSCHAFT, Munchen (DE)

(21) Appl. No.: 09/730,897

(22) Filed: Dec. 6, 2000

(30) Foreign Application Priority Data
Dec. 6, 1999 (DE) 199 58 682.9

(51) Int. Cl. H02K 3/00

(52) U.S. Cl. 310/180; 310/162

(57) ABSTRACT

A permanent magnet synchronous motor includes a stator and a permanent magnet excited rotor, with the stator provided with a winding which has cyclically repeating winding factors |ξₚ|=0.945, |ξ₅ₚ|=0.140, and |ξ₇ₚ|=0.060, and a skew angle

$$γ = \frac{2 π}{18 p} ,$$

wherein p is the number of pole pairs.

### CROSS-REFERENCES TO RELATED APPLICATIONS

This application claims the priority of German Patent Application Ser. No. 199 58 682.9, filed Dec. 6, 1999, the subject matter of which is incorporated herein by reference.

### BACKGROUND OF THE INVENTION

The present invention relates to a permanent magnet synchronous motor, and more particularly to a 4-pole motor.

High-speed permanent magnet synchronous motors have typically four poles as determined by the maximum voltage converter frequency. The running concentricity of a synchronous motor, in particular of the motor spindle, has to be very high, requiring suitable measures for suppressing torque ripple. This in turn typically requires a relatively complex winding system with the following parameters:

Number of slots in the stator N=36.

Number of poles 2p=4.

Pitch factor w/τ=7/9.

Skew angle of the stator γ=10°.

### SUMMARY OF THE INVENTION

It is thus an object of the present invention to provide an improved permanent magnet synchronous motor, obviating the afore-stated drawbacks.

In particular, it is an object of the present invention to provide an improved permanent magnet synchronous motor with a winding system which generates electromagnetic effects similar to those of a winding system of a conventional permanent magnet synchronous motor while yet can be manufactured in a more simple manner.

These objects, and others which will become apparent hereinafter, are attained in accordance with the present invention by providing a stator and a permanent magnet excited rotor, wherein the stator has a winding with cyclically repeating winding factors |ξₚ|=0.945, |ξ₅ₚ|=0.140 and |ξ₇ₚ|=0.060, and a skew angle

$$γ = \frac{2 π}{18 p} ,$$

wherein p is the number of pole pairs.

In a configuration of the stator with a slot number N=18 slots, the winding is formed as a single layer winding, wherein the three winding factors repeat cyclically. The optimal skew angle is

$$γ = \frac{2 π}{18 p} .$$

There is also the option to reduce the slot number of the stator by one half, so that only N=9 slots are provided in the stator. In this case, the winding is a special two-layer winding. Again, three possible winding factors exist which are identical to those of the afore-described winding system with N=18 slots. The optimal skew angle of the stator in this case is also

$$γ = \frac{2 π}{18 p} .$$

The winding arrangement disclosed in the present invention is particularly suited for small-size, high-speed four pole synchronous spindles. This winding arrangement in conjunction with a mutual skew between the rotor and the stator optimally suppresses torque ripple. Slot latching is therefore encountered only as of the fourth slot harmonic. The term “slot latching” will denote a physical effect in which latching torque is effective in particular at standstill and during starting. A reduction of latching torque can be realized, e.g., by skewing the slot.

### BRIEF DESCRIPTION OF THE DRAWING

The above and other objects, features and advantages of the present invention will be more readily apparent upon reading the following description of a preferred exemplified embodiment of the invention with reference to the accompanying drawing, in which:

FIG. 1 is a zone layout of a single layer winding with a slot number N=18 slots;

FIG. 2 is a zone layout of a two-layer winding with a slot number N=9 slots;

FIG. 3 is a winding diagram of a strand of a two-layer winding with the slot number N=9 slots; and

FIG. 4 is a fragmentary section view of a stator of the synchronous motor according to the present invention.

### DETAILED DESCRIPTION OF PREFERRED EMBODIMENTS

Throughout all the Figures, same or corresponding elements are generally indicated by same reference numerals.

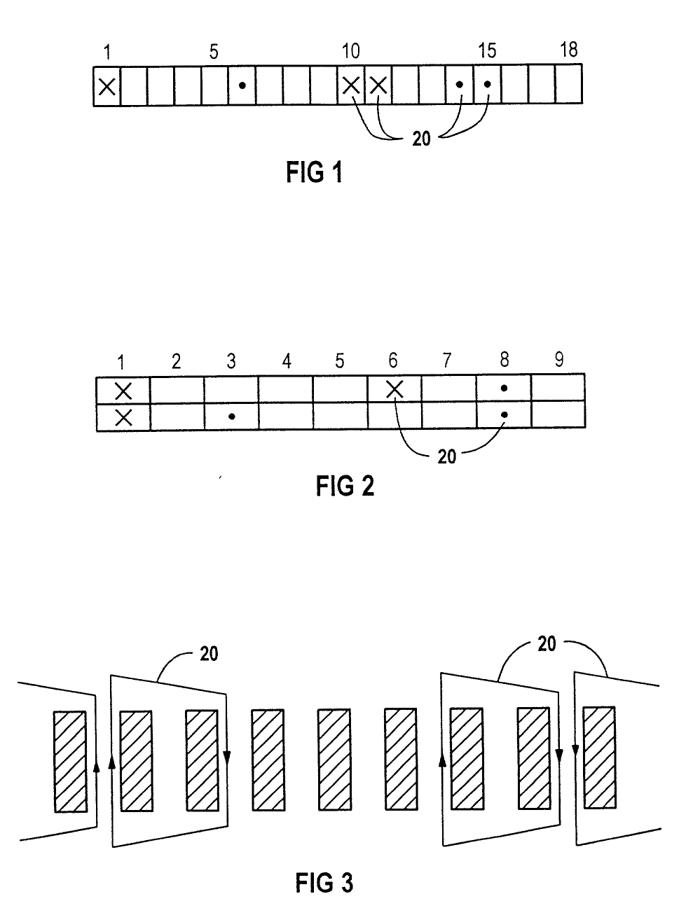

Turning now to the drawing, and in particular to FIG. 1, there is shown a zone layout for a winding strand of a single layer winding, e.g. prefabricated coils, for use in a permanent magnet synchronous motor. It will be appreciated by persons skilled in the art that the synchronous motor must contain much mechanical apparatus which does not appear in the foregoing Figures, e.g. a stator and a rotor whereby the rotor includes permanent magnets which are arranged on its outer circumference or interiorly of the rotor. However, this apparatus, like much other necessary apparatus, is not part of the invention, and has been omitted from the Figures for the sake of simplicity.

The stator, involved here, and shown by way of example in FIG. 4, is formed by a stack 21 of laminations of magnetic material, such as sheet metal, suitably joined together thereby defining slots 22 between neighboring tees 23, for accommodating windings 20 of electric conductor. By way of example, a suitable stator assembly includes a slot number N=18 slots, i.e. a series of 18 slots 22 spaced about the circumference, with each slot 22 having a gap 25 adjacent the air-gap between stator and rotor. The three possible winding factors are hereby as follows:

|ξₚ|=0.945

|ξ₅ₚ|=0.140, and

|ξ₇ₚ|=0.060.

In the following description, the term “winding factor” will denote a reduction of the induced voltage encountered in a group of spaced coils as compared to a concentric disposition in which all conductors include the entire flux of a pole pitch. The winding factor is a number which depends on zone width, slotting and pitch factor and depends essentially on the order of the observed upper harmonic field. Thus, the spatial distribution of the winding is of relevance when dimensioning the machine to generate a sinusoidal voltage when a generator is concerned and a sinusoidal rotary field when a motor is concerned.

The above winding factors repeat cyclically. Windings of this type are suitable for both rotary motors and linear motors. The optimum skew angle in this case is

$$γ = \frac{2 π}{18 p} ,$$

wherein p is the number of pole pairs.

In the layout of the single layer stator winding of FIG. 1 with the slot number N=18 slots, an X indicates the direction of the current in the winding 20 flowing into the drawing plane, whereas a dot indicates a current flow of the winding out of the drawing plane. The winding includes the least one turn. The slots 1 to 18 for receiving the winding 20 are semi-open slots or open slots. To facilitate positioning of the winding 20 in the slots 22, whereby the slot number N=1 to 18, the gap 25 has a width which is at least half the width W of the slot 22.

The winding 20 can be secured in the slots N by conventional processes, for example by encapsulation through casting or use of locking wedges, which are preferably mechanically affixed to the laminated core.

FIG. 2 shows a layout of a two-layer stator winding with a slot number N=9. The winding 20 of this second embodiment has the same winding factors as the single layer winding of a stator with the slot number N=18 slots.

|ξₚ|=0.945

|₅ₚ|=0.140, and

|ξ₇ₚ|=0.060.

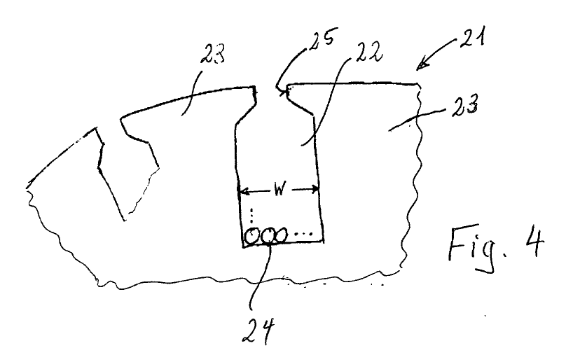

FIG. 3 shows a winding diagram of a strand for the stator with N=9 slots according to FIG. 2.

While the invention has been illustrated and described as embodied in a permanent magnet synchronous motor, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A permanent magnet synchronous motor comprising a stator and a permanent magnet excited rotor, said stator including a winding which has cyclically repeating winding factors |ξₚ|=0.945, |ξ₅ₚ|=0.140, and |ξ₇ₚ|=0.060, and a skew angle
$$γ = \frac{2 π}{18 p} ,$$
wherein p is the number of pole pairs.

2. The synchronous motor of claim 1, wherein the winding is a 4-pole two-layer winding, and the stator has a slot number N=9 slots.

3. The synchronous motor of claim 1, wherein the winding includes prefabricated coils.

4. The synchronous motor of claim 1, wherein the stator includes a laminated core with a slot skew of at least half a slot pitch.

5. The synchronous motor of claim 1, wherein the rotor has an outer circumference and includes permanent magnets which are arranged on the outer circumference of the rotor.

6. The synchronous motor of claim 1, wherein the rotor includes permanent magnets which are arranged interiorly of the rotor.
